(19) United States
(12) Patent Application Publication
(10) Pub. No.: US 2024/0410756 A1
(43) Pub. Date: Dec. 12, 2024

(54) RAMAN MEASUREMENT DEVICE

(71) Applicant: TOP TECHNOLOGY PLATFORM CO., LTD., Hsinchu City (TW)

(72) Inventors: YU NIEN LU, Hsinchu City (TW); FENG-MIN SHEN, Hsinchu City (TW)

(21) Appl. No.: 18/485,756

(22) Filed: Oct. 12, 2023

(30) Foreign Application Priority Data
Jun. 6, 2023 (TW) 112205691

(51) Int. Cl. G01J 3/44; G01N 21/65

(52) U.S. Cl. CPC G01J 3/4412; G01N 21/65

(57) ABSTRACT

A proposed Raman measurement device has a housing, an optical module, and a measuring probe. The measuring probe is connected to the optical module which is installed in the housing. A part of the measuring probe protrudes from the housing. An open end of the measuring probe outputs an emitted light from a laser light source in the optical module and receives the Raman scattered light excited from a surface to be detected. The axial centerline of the measuring probe and any parallel line in the length direction of the housing include an angle of 15° to 50° and the effective focusing distance between the open end of the measuring probe and the surface to be detected is 7 mm to 9 mm.

### TECHNICAL FIELD

The present invention relates to a measurement device, in particular to a Raman measurement device.

### BACKGROUND

A conventional Raman spectrometer is known for projecting laser light on a surface, which is to be detected, of a solid, liquid or powder to make the surface excite scattered light, and then measuring the Raman spectrum of the scattered light. A Raman spectrometer usually has a probe to perform a distal sampling during the measurement of the spectrum of the surface. However, the quality and effect of the measurement vary due to the different substances contained on or under the surface. Therefore, the technical issue to be solved would be application of the measurement principle of a Raman spectrometer to measure surfaces containing various substances, such as a coating surface, and to obtain the best measurement.

### SUMMARY

In view of the above problems, the inventors of this application propose a new type of Raman measurement device to perform Raman spectrum measurement on surfaces containing various substances, such as a coating surface, and the measurement results were proved to be great.

In one embodiment, the proposed Raman measurement device has a housing, an optical module, and a measuring probe. The optical module is partly or wholly packed in the housing, and a laser light source is arranged in the optical module. The measuring probe is connected to the optical module and partly or wholly protrudes from the housing. A first angle is included between an axial centerline of the measuring probe and one parallel line in the length direction of the housing. An emitted light from the laser light source exits an open end of the measuring probe and is focused on a surface to be detected. An effective focusing distance between the open end and the surface is 7 mm to 9 mm, the first angle is between 5 degrees and 60 degrees, and the open end receives a Raman scattered light excited from the surface. The first angle is preferably 15 degrees to 50 degrees.

In one embodiment, the proposed Raman measurement device further includes a light shield connected to the housing and formed with a barrier wall positioned at the opposite side of the open end of the measuring probe, wherein the distance between the barrier wall and the open end is greater than the effective focusing distance.

In one embodiment, the optical module and the measuring probe are assembled to form a probe device which is to be placed in a receiving space of the housing and to be fixed onto the housing.

In one embodiment, the optical module is arranged along the length direction of the housing.

In one embodiment, the housing is formed with an inclined surface which is parallel to the axial centerline of the measuring probe.

In one embodiment, two supporting walls are respectively formed on both sides of the inclined surface of the housing. The supporting walls are longitudinally extended to be perpendicular to the length direction of the housing. The optical module is placed in the receiving space surrounded by the supporting walls. Each of the supporting walls has a through hole formed in the direction parallel to the normal direction of the supporting walls. The through hole is inserted with a locking element to fix the optical module or the measuring probe onto the housing.

In one embodiment, the proposed Raman measurement device further includes a fixing seat, which has a first wall and a second wall perpendicular to each other to have an L-shape contour. The first wall has a first through hole, and the second wall has a second through hole. The first through hole is used for the measuring probe to penetrate, and the second through hole is used for a locking element to penetrate to fix the second wall onto the inclined surface.

In one embodiment, a second angle is included between the axial centerline of the measuring probe and the normal direction of the area of the surface to be detected, and the sum of the second angle and the first angle is 90 degrees.

In each embodiment, the optical module has a light source module, a beam splitting module and a light focusing module. The light source module has the laser light source, the light splitting module is connected to the light source module, and the light focusing module is connected to the light splitting module to receive the emitted light from the laser light source before the emitted light is focused on the surface to be detected.

In summary, the Raman measurement device of each embodiment of the present invention enables that the normal direction of the area of the surface T to be detected (the direction perpendicular to the area of the surface T) and the axial centerline of the measuring probe of the Raman measurement device include a non-zero second angle and that the sum of the second angle and the above-mentioned first angle is 90 degrees. This makes the area of the surface T on which the emitted laser light from the Raman measurement device projected become larger and therefore helps the measuring probe to receive more optical signals from the surface T. Moreover, the reception of the interference lights excited or scattered from the surface T by various substances, such as polymers, on or under the surface T by the measuring probe can be reduced, because these interference lights do not directly face the measuring probe. Thereby, the measurement accuracy and efficiency are improved. The surface T to be detected in each embodiment may be a coating surface. Experimental data shows that the inclined measuring probe obtained good measuring results for any surface, especially a coating surface. In the above-mentioned embodiments, although the measuring probes are preferably circular cylinders, other shapes for the cylinders are possible in other embodiments. As long as the axial centerlines of these measuring probes and any parallel line in the length direction of the housing include a non-zero angle so that another non-zero angle included between the normal direction of the area of the surface T to be detected and the axial centerline of the Raman measurement device, the shape of the measuring probe is not limited.

Various other objects, advantages and features of the present invention will become readily apparent from the ensuing detailed description accompanying drawings, and the novel features will be particularly pointed out in the appended claims.

### BRIEF DESCRIPTION OF DRAWINGS

The following detailed descriptions, given by way of example, and not intended to limit the present invention solely thereto, will be best be understood in conjunction with the accompanying figures.

FIG. 1A is an overall perspective view of a Raman measurement device of a first embodiment of the present invention.

FIG. 1B is a systematic diagram of an optical module of the Raman measurement device of the first embodiment of the present invention.

FIG. 2A is an overall perspective view of a Raman measurement device of a second embodiment of the present invention.

FIG. 2B is a schematic diagram of the combination of a housing with a measuring probe of the Raman measurement device of the second embodiment of the present invention.

FIG. 2C is a perspective view of the hosing of the Raman measurement device of the second embodiment of the present invention.

FIG. 3A is a cross-sectional perspective view of a Raman measurement device of a third embodiment of the present invention.

FIG. 3B is an enlarged perspective view of an area A in FIG. 3A.

### DETAILED DESCRIPTION OF THE EMBODIMENTS

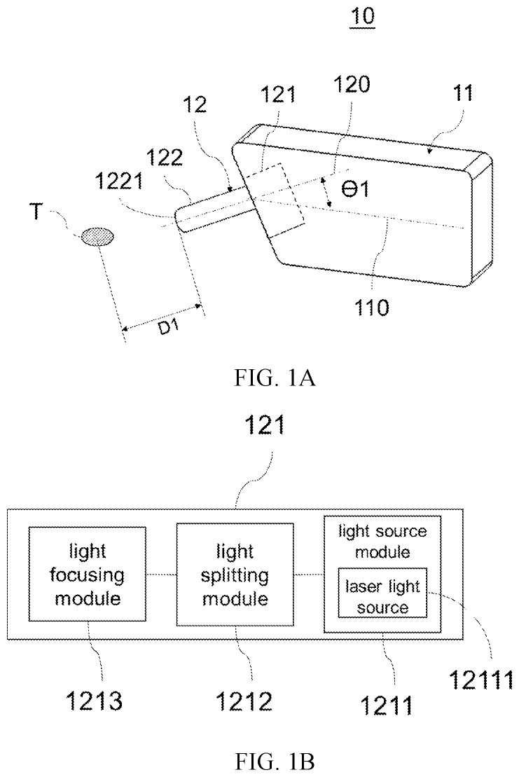

FIG. 1A is an overall perspective view of a Raman measurement device of a first embodiment of the present invention. FIG. 1B is a systematic diagram of an optical module of the Raman measurement device of the first embodiment of the present invention. As shown in FIGS. 1A and 1B, in a first embodiment, the Raman measurement device 10 has a housing 11 and a probe device 12 assembled with the housing 11. The probe device 12 includes an optical module 121 (indicated by a dotted line) and a measuring probe 122. While connected to the measuring probe 122, the optical module 121 is partly or wholly packed in the housing 11 and preferably arranged along the length direction of the housing 11. The length direction of the housing 11 means the largest size direction among the three dimensions of the housing 11. The measuring probe 122 partly or wholly protrudes from the housing 11. The optical module 121 has a light source module 1211, a light splitting module 1212 and a light focusing module 1213. The light source module 1211 has a laser light source 12111. The light splitting module 1212 is connected with the light source module 1211. The light focusing module 1213 is connected with the light splitting module 1212. An emitted light from the laser light source passes through the light splitting module and the light focusing module to reach a targeted area. The principles for the various modules inside the optical module 121 to work are well known to those skilled in the art and would not be described below. In this embodiment, an emitted light from the laser light source 12111 passes through the light focusing module 1213 and exits an open end 1221 of the measuring probe 122 and is focused on a surface T to be detected. After that, a Raman scattered light excited from the surface T to be detected is received by the open end 1221 of the measuring probe 122. In this embodiment, the measuring probe 122 is preferably a circular cylinder having an axial centerline 120, which is a virtual line passing through the center of the measuring probe 122 and being parallel to the axial direction of the measuring probe 122, and one parallel line 110 (a virtual line shown as a dotted line) along the length direction of the housing 11 to include a first angle Θ1 being between 5 degrees and 60 degrees, preferably 15 degrees to 50 degrees. Additionally, the effective focus distance D between the open end 1221 and the surface T to be detected 1 is 7 mm to 9 mm. The effective focus distance means a distance within which the focus operation can only be performed.

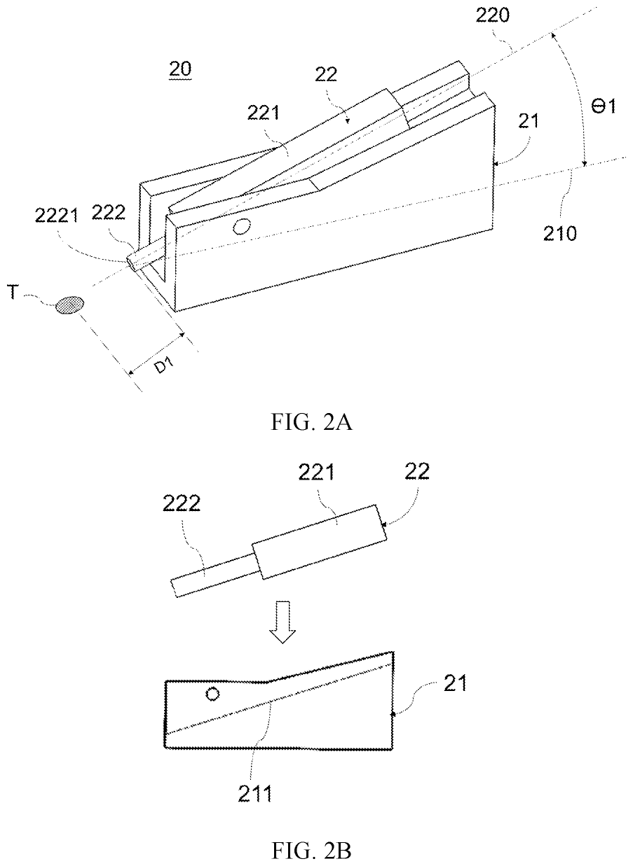

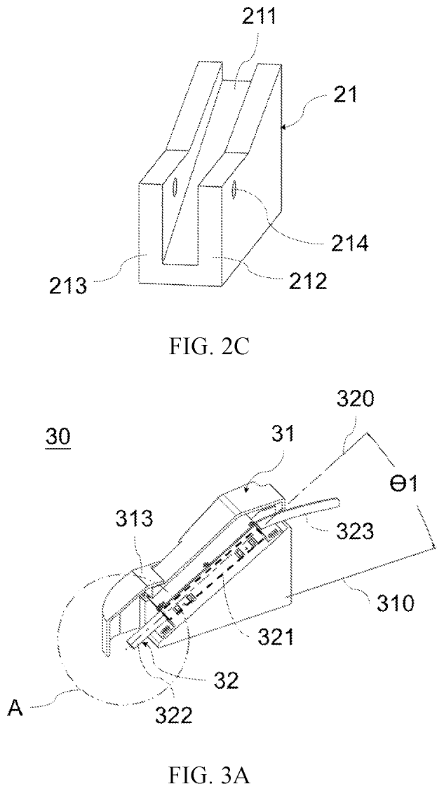

FIG. 2A is an overall perspective view of a Raman measurement device of a second embodiment of the present invention. FIG. 2B is a schematic diagram of the combination of a housing with a measuring probe of the Raman measurement device of the second embodiment of the present invention. FIG. 2C is a perspective view of the hosing of the Raman measurement device of the second embodiment of the present invention. As shown in FIG. 2A and FIG. 2B, in a second embodiment, the Raman measurement device 20 still has a housing 21 and a probe device 22 assembled with the housing 21. The probe device 22 includes an optical module 221 and a measuring probe 222. The measuring probe 222 is connected to the optical module 221. The optical module 221 is partly or wholly packed in the housing 21, and the measuring probe 222 partly or wholly protrudes from the housing 21. In this embodiment, the optical elements inside the optical module 221 are the same as those inside the optical module 121 in the first embodiment and would not be described repeatedly here. Like the first embodiment, the emitted light from the laser light source in the optical module 221 in this embodiment passes through the light focusing module and exits an open end 2221 of the measuring probe 222 and then is focused on a surface T to be detected. The Raman scattered light excited from the surface T is received by the open end 2221 of the measuring probe 222. In addition, the measuring probe 222 in this embodiment is preferably a circular cylinder having an axial centerline 220, which is a virtual line passing through the center of the measuring probe 222 and being parallel to the axial direction of the measuring probe 122, and one parallel line 210 (a virtual line shown as a dotted line) along the length direction of the housing 21 to include a first angle Θ1 being between 5 degrees and 60 degrees, preferably 15 degrees to 50 degrees. Additionally, the effective focus distance D1 between the open end 2221 and the surface T is 7 mm to 9 mm. The length direction of the housing 21 means the largest size direction among the three dimensions of the housing 21. The effective focus distance means a distance within which the focus operation can only be performed. Being different from the first embodiment, the Raman measurement device 20 in the second embodiment is that the probe device 22 is assembled to the housing 21 in the direction indicated by the arrow in FIG. 2B and placed in a receiving space of the housing 21. As shown in FIGS. 2A to 2C, the housing 21 is formed with an inclined surface 211 which is parallel to the axial centerline 220 of the measuring probe 222. In this way, the axial centerline 220 of the measuring probe 222 and one parallel line 210 in the length direction of the housing 21 include the above-mentioned first angle Θ1, while the optical module 221 is placed in the receiving space and arranged along the length direction of the housing 21. Two supporting walls 212 and 213 extending in the longitudinal direction of the housing 21, which is perpendicular to the length direction of the housing 21, are respectively formed on both sides, i.e., right side and left side, of the inclined surface 211. The optical module 221 or the entire probe device 22 including the optical module 221 and the measuring probe 222 is placed in the receiving space surrounded by the supporting walls 212 and 213. Each of the supporting walls has a through hole 214 formed in the direction parallel to the normal direction of the supporting walls 212 and 213. Each through hole 214 is used to be inserted with a locking element (not shown) to fix the optical module 221 or the measuring probe 222 onto the housing 21. The locking element can be but not limited to a bolt, a screw, or a rivet. In this way, before using the Raman measurement device 20, a user can first slide the probe device 22 on the inclined surface 211 to calibrate the effective focus distance D1 between the open end 2221 of the measuring probe 222 and the surface T, and then fix the probe device 22 onto the housing 21 when the calibration is ready. Alternatively, the user can recalibrate the focus distance D1 after a period of usage of the Raman measurement device 20. In this embodiment, if the supporting walls 212 and 213 have the capability to clamp the entire probe device 22 onto the inclined surface 211, the geometric shapes of the supporting walls 212 and 213 are not limited.

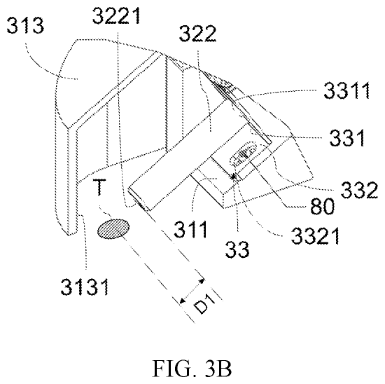

FIG. 3A is a cross-sectional perspective view of a Raman measurement device of a third embodiment of the present invention. FIG. 3B is an enlarged perspective view of an area A in FIG. 3A. As shown in FIG. 3A and FIG. 3B, a Raman measurement device 30 in a third embodiment still has a housing 31 and a probe device 32 assembled with the housing 31. The probe device 32 includes an optical module 321, a measuring probe 322 and an optical fiber tube 323. The measuring probe 322 is connected to the optical module 321. The optical module 321 is packed in the housing 31 and preferably arranged along the length direction of the housing 31. The length direction of the housing 31 means the direction with the largest size among the three dimensions of the housing 31. The measuring probe 322 partly or wholly protrudes from one side of the housing 31. The optical fiber tube 323 has an optical fiber connected to an optical signal analysis device such as a Raman spectrometer and protrudes from the other side of the housing 31. In this embodiment, the optical elements inside the optical module 321 are the same as those inside the optical module 121 in the first embodiment and would not be described repeatedly herein. Like the first and second embodiments, the emitted light from the laser light source in the optical module 321 in this embodiment passes through the light focusing module and exits an open end 3221 of the measuring probe 322 and then is focused on a surface T to be detected. After that, the Raman scattered light excited from the surface T is received by the open end 3221 of the measuring probe 322. In addition, the measuring probe 322 in this embodiment is preferably a circular cylinder having an axial centerline 320, which is a virtual line passing through the center of the measuring probe 322 and being parallel to the axial direction of the measuring probe 322, and one parallel line 310 along the length direction of the housing 31 include a first angle Θ1 being between 5 degrees and 60 degrees, preferably between 15 degrees to 50 degrees. Moreover, the effective focus distance D1 between the open end 3221 and the surface T is 7 mm to 9 mm. As shown in FIGS. 3A and 3B, the housing 31 in this embodiment is still formed with an inclined surface 311 parallel to the axial centerline 320 of the measuring probe 322, so that the probe device 32 can be arranged to be attached to the inclined surface 311 and then be assembled to the housing 31, and therefore the axial centerline 320 of the measuring probe 322 and the parallel line 310 in the length direction of the housing 31 include the above-mentioned first angle Θ1. In addition, as shown in FIGS. 3A and 3B, the Raman measurement device 30 in this embodiment further has a light shield 313 which may be another piece of component connected to the housing 31 or a part integrally formed with the housing 31. The light shield 313 is formed with a barrier wall 3131 positioned at the opposite side of the open end 3221 of the measuring probe 322, and the distance between the barrier wall 3131 and the open end 3221 is greater than the effective focusing distance D1 between the surface T and the open end 3221 of the measuring probe 322. In this way, the ambient light outside the Raman measurement device 30 is blocked by the barrier wall 3131 from entering the focusing area between the measuring probe 322 and the surface T, and any interferences to the measuring process can be avoided. In addition, the Raman measurement device 30 in this embodiment can have a fixing seat 33 including a first wall 331 and a second wall 332 that are perpendicular to each other to have an L-shape. The first wall 331 has a first through hole 3311, and the second wall 332 has a second through hole 3321. The first through hole 3311 is used for the measuring probe 322 to penetrate, and the second through hole 3321 is used for a locking element 80 to penetrate to fix the second wall 332 onto the inclined surface 311. The locking element 80 may be but not limited to a bolt, a screw, or a rivet. Similar to the second embodiment, the user can first slide the probe device 32 on the inclined surface 311 to calibrate the effective focus distance D1 between the open end 3221 of the measuring probe 322 and the surface T and then fix the probe device 32 onto the housing 31 when the calibration of the focus distance D1 is ready in advance of the usage of the Raman measurement device 30 in this embodiment. Alternatively, the user can recalibrate the focus distance D1 after a period of usage of the Raman measurement device 30.

In summary, the Raman measurement device of each embodiment of the present invention enables that the normal direction of the area of the surface T to be detected (the direction perpendicular to the area of the surface T) and the axial centerline of the measuring probe of the Raman measurement device include a non-zero second angle and that the sum of the second angle and the above-mentioned first angle is 90 degrees. This makes the area of the surface T on which the emitted laser light from the Raman measurement device projected become larger and therefore helps the measuring probe to receive more optical signals from the surface T. Moreover, the reception of the interference lights excited or scattered from the surface T by various substances, such as polymers, on or under the surface T by the measuring probe can be reduced, because these interference lights do not directly face the measuring probe. Thereby, the measurement accuracy and efficiency are improved. The surface T to be detected in each embodiment may be a coating surface. Experimental data shows that the inclined measuring probe obtained good measuring results for any surface, especially a coating surface. In the above-mentioned embodiments, although the measuring probes 122, 222, and 322 are preferably circular cylinders, other shapes for the cylinders are possible in other embodiments. As long as the axial centerlines of these measuring probes and any parallel line in the length direction of the housing include a non-zero angle so that another non-zero angle included between the normal direction of the area of the surface T to be detected and the axial centerline of the Raman measurement device, the shape of the measuring probe is not limited.

Having described at least one of the embodiments of the claimed invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure covers modifications and variations of this disclosure provided they come within the scope of the appended claims and their equivalents. Specifically, one or more limitations recited throughout the specification can be combined in any level of details to the extent they are described to conduct the Raman measurement device.

1. A Raman measurement device, comprising:
a housing;
an optical module being partly or wholly packed in the housing;
a laser light source being arranged in the optical module; and
a measuring probe being connected to the optical module, partly or wholly protruding from the housing, and an axial centerline of the measuring probe and one parallel line along the length direction of the housing including a first angle;
wherein an emitted light from the laser light source exits an open end of the measuring probe and is focused on a surface to be detected, an effective focusing distance between the open end and the surface is 7 mm to 9 mm, the first angle is between 5 degrees and 60 degrees, and the open end receives a Raman scattered light excited from the surface.

2. The Raman measurement device of claim 1, wherein the first angle is between 15 degrees and 50 degrees.

3. The Raman measurement device of claim 1, further comprising:
a light shield connected to the housing and formed with a barrier wall positioned at the opposite side of the open end of the measuring probe, wherein the distance between the barrier wall and the open end is greater than the effective focusing distance.

4. The Raman measurement device of claim 1, wherein the optical module and the measuring probe are assembled to form a probe device which is to be placed in a receiving space of the housing and to be fixed onto the housing.

5. The Raman measurement device of claim 1, wherein the optical module is arranged along the length direction of the housing.

6. The Raman measurement device of claim 1, wherein the housing is formed with an inclined surface being parallel to the axial centerline of the measuring probe.

7. The Raman measurement device of claim 6, wherein two supporting walls are respectively formed on both sides of the inclined surface and longitudinally extended to be perpendicular to the length direction of the housing, and the optical module is placed in the receiving space surrounded by the supporting walls, each of the supporting walls has a through hole formed in the direction parallel to the normal direction of the supporting walls, and the through hole is inserted with a locking element to fix the optical module or the measuring probe onto the housing.

8. The Raman measurement device of claim 6, further comprising:
a fixing seat having a first wall and a second wall perpendicular to each other to have an L-shape contour, wherein the first wall has a first through hole, the second wall has a second through hole, the first through hole is used for the measuring probe to penetrate, and the second through hole is used for a locking element to penetrate to fix the second wall onto the inclined surface.

9. The Raman measurement device of claim 1, wherein a second angle is included between the axial centerline of the measuring probe and the normal direction of the area of the surface to be detected, and the sum of the second angle and the first angle is 90 degrees.

10. The Raman measurement device of claim 1, wherein the optical module comprises:
a light source module having the laser light source;
a light splitting module connected with the light source module; and
a light focusing module connected with the light splitting module to receive the emitted light from the laser light source before the emitted light is focused on the surface to be detected.
